(19) United States
(12) Patent Application Publication
(10) Pub. No.: US 2013/0201127 A1
(43) Pub. Date: Aug. 8, 2013

(54) INPUT DEVICE

(71) Applicant: ALPS ELECTRIC CO., LTD., Tokyo (JP)

(72) Inventors: Norio ABE, Miyagi-ken (JP); Takashi ONOZATO, Miyagi-ken (JP); Tomokuni WAUKE, Miyagi-ken (JP)

(73) Assignee: ALPS ELECTRIC CO., LTD., Tokyo (JP)

(21) Appl. No.: 13/745,497

(22) Filed: Jan. 18, 2013

(30) Foreign Application Priority Data
Feb. 8, 2012 (JP) 2012-024731

(51) Int. Cl. G06F 3/01

(52) U.S. Cl. CPC G06F 3/016
USPC 345/173

(57) ABSTRACT

On a lower case serving as a supporting base, a movable unit is supported to be able to vibrate in an X direction, with a first elastic member interposed therebetween. In the movable unit, a panel assembly is supported on a movable base to be able to vibrate in a Z direction, with a second elastic member interposed therebetween. A vibration generator is mounted on the panel assembly and supported by a third elastic member on the movable base. When the vibration generator generates vibration in the X direction, the entire movable unit vibrates in the X direction. When the vibration generator generates vibration in the Z direction, the panel assembly vibrates in the Z direction. When the panel assembly is pressed with a finger, the force of the pressing operation can be detected by a second detector which is a force sensor.

### CLAIM OF PRIORITY

This application claims benefit of Japanese Patent Application No. 2012-024731 filed on Feb. 8, 2012, which is hereby incorporated by reference.

### BACKGROUND OF THE INVENTION

1. Field of the Invention

The present invention relates to an input device that can apply vibration from a vibration generator to an operation surface when the operation surface is operated with a finger or the like. In particular, the present invention relates to an input device that can effectively vibrate an operation surface.

2. Description of the Related Art

A portable electronic device described in Japanese Unexamined Patent Application Publication No. 2010-108210 has a touch input panel that can be operated with a finger. The touch input panel is supported by a chassis. A vibrator is interposed between the chassis and a cover member that covers a back side of the chassis. Vibration generated by the vibrator is applied to the touch input panel.

In an input device described in Japanese Unexamined Patent Application Publication No. 2006-139371, a display unit having a touch panel on a surface thereof is supported by a housing, with an elastic supporting member interposed therebetween. An exciting unit attached to the display unit is vibrated in a direction intersecting the plane of the touch panel. The invention disclosed in Japanese Unexamined Patent Application Publication No. 2006-139371 provides a technique in which a distance between nodes of vibration applied from the exciting unit to the display unit is adjusted to the width of the display unit to increase the amplitude of vibration of the display unit.

The portable electronic device described in Japanese Unexamined Patent Application Publication No. 2010-108210 has a structure in which the vibrator is interposed between the chassis and the cover member. With this structure, in which vibration from the vibrator is transmitted mainly to the chassis and the cover member, the strength of vibration applied to the touch input panel decreases. As a result, vibration felt with the finger touching the touch input panel is considerably weakened. Additionally, application of an appropriate strength of vibration to the touch input panel requires a large vibrator that can produce a large output.

In the input device described in Japanese Unexamined Patent Application Publication No. 2006-139371, the display unit having the touch panel can be vibrated only in a direction orthogonal to the operation surface. If vibration can be applied to a finger touching the surface of the touch panel only in a vertical direction, it is difficult to apply an optimum operation reaction force to the finger.

With the techniques described in Japanese Unexamined Patent Application Publication No. 2010-108210 and Japanese Unexamined Patent Application Publication No. 2006-139371, the vibrator and the exciting unit can apply only a single mode of vibration and cannot apply various types of vibration to the operation surface.

The present invention solves the problems of the related art described above. The present invention provides an input device that can effectively apply vibration to a finger that touches an operation surface.

The present invention also provides an input device that can effectively apply two types of vibration to an operation surface.

### SUMMARY OF THE INVENTION

An input device according to an aspect of the present invention includes a supporting base, and a movable unit disposed to be able to vibrate over the supporting base with a first elastic member interposed therebetween. The movable unit has an operation surface, a detector configured to detect an operation on the operation surface, and a vibration generator configured to apply vibration to the operation surface. The vibration generator generates vibration having a vibration frequency equal to a natural vibration frequency at which the movable unit vibrates in a direction along the operation surface.

In the input device described above, the movable unit having the operation surface is vibrated in the direction along the plane of the operation surface. When a finger is placed on the operation surface, vibration along the plane of the operation surface can be felt with the finger more strongly than vibration perpendicular to the finger. When the vibration generator causes the operation surface to resonate in the direction along the plane, the operation reaction force can easily act on the finger operating the operation surface.

In the input device described above, the movable unit may include a movable base supported by the first elastic member, and a movable panel having the operation surface, the detector, and the vibration generator. The movable panel may be supported to be able to vibrate over the movable base, with a second elastic member interposed therebetween. The vibration generator may generate vibration having a first vibration frequency equal to a natural vibration frequency of the entire movable unit, and vibration having a second vibration frequency equal to a natural vibration frequency of the movable panel.

For example, the vibration generator may vibrate the entire movable unit in a direction along the operation surface, and may vibrate the movable panel in a direction intersecting the operation surface.

By resonating the entire movable unit at the first vibration frequency and resonating the movable panel at the second vibration frequency, it is possible to make the user feel two types of vibration transmitted to the finger touching the operation surface.

In the input device described above, a first detector configured to detect a position of operation on the operation surface may be mounted on the movable panel, a second detector configured to detect a pressing force applied to the movable panel may be mounted on the movable base, and the vibration generator may be secured to the movable panel.

When the movable panel, which is supported on the movable base with the second elastic member interposed therebetween, is pressed with a finger, the movable panel can be displaced to activate the second detector. Since the movable panel is supported on the movable base with the second elastic member interposed therebetween, the second detector can be activated as described above. There is a difference in natural vibration frequency between the entire movable unit and the movable panel. Therefore, when the entire movable unit is vibrated at the first vibration frequency in the direction of the plane of the operation surface, the movable panel can vibrate in the direction of the plane in accordance with the vibration of the entire movable unit.

In the input device described above, a mass of the supporting base is preferably larger than a mass of the entire movable unit.

With the larger mass of the supporting base, even when the movable unit resonates on the supporting base, the vibration is not easily transmitted to the supporting base. Therefore, it is possible to effectively apply vibration generated by the vibration generator to the operation surface.

An input device according to another aspect of the present invention includes a supporting base being a case, and a movable unit supported on the supporting base with a first elastic member interposed therebetween. The movable unit includes a movable base, and a movable panel supported on the movable base with a second elastic member interposed therebetween. The movable panel has an operation surface, a first detector configured to detect a position of operation on the operation surface, and a vibration generator configured to generate vibration having a first vibration frequency equal to a natural vibration frequency of the entire movable unit and vibration having a second vibration frequency equal to a natural vibration frequency of the movable panel. The movable base has a second detector configured to detect a pressing force applied to the movable panel.

In the input device described above, the vibration generator may be secured to the movable panel, and a third elastic member may be interposed between the movable base and the vibration generator.

Also in the input device described above, the vibration generator may vibrate the entire movable unit in a direction along the operation surface, and may vibrate the movable panel in a direction intersecting the operation surface.

According to either aspect of the present invention, the input device can effectively apply vibration generated by the vibration generator to the operation surface. Also, the input device can apply two types of vibration to the operation surface.

If the input device includes the first detector configured to detect a position of operation on the operation surface and the second detector configured to detect a pressing force applied to the operation surface, since the operation surface moves in the direction of the press, the second detector can sensitively detect the pressing force. Additionally, the input device can effectively apply vibration to the operation surface both in the direction of the plane of the operation surface and in the direction intersecting the plane, in a non-interfering state.

### BRIEF DESCRIPTION OF THE DRAWINGS

FIG. 1 is a perspective view of an input device according to an embodiment of the present invention;

FIG. 2 is an exploded perspective view illustrating major components of the input device illustrated in FIG. 1;

FIG. 3 is a cross-sectional view of the input device illustrated in FIG. 1, taken along line III-III;

FIG. 4 is a diagram for explaining a vibration model of the input device;

FIG. 5 is an exploded perspective view of a vibration generator included in the input device according to an embodiment of the present invention;

FIG. 6 is a bottom view of a vibrating body and elastic supporting members included in the vibration generator illustrated in FIG. 5;

FIG. 7 is a cross-sectional view taken along line VII-VII of FIG. 6;

FIG. 8 is an enlarged plan view of an elastic supporting member included in the vibration generator;

FIG. 9A and FIG. 9B illustrate an arrangement of magnets in a magnetic driving unit included in the vibration generator; and

FIG. 10 is a block diagram of a driving circuit unit for driving the vibration generator.

### DESCRIPTION OF THE PREFERRED EMBODIMENTS

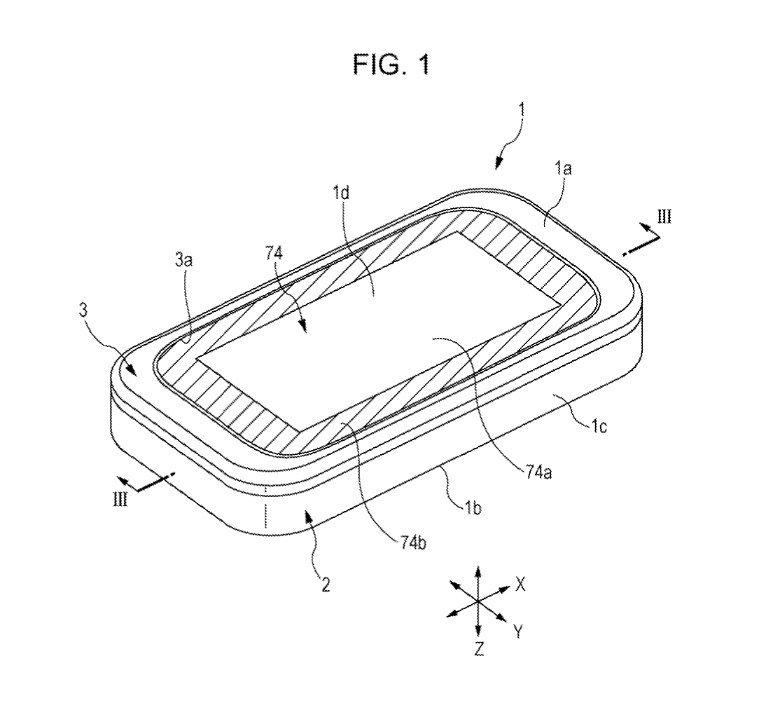

An input device 1 illustrated in FIG. 1 is used, for example, as a portable media player, a remote control for various electronic devices, a portable game device, a portable communication device, or a portable information processing device.

The input device 1 has a front surface 1a, a back surface 1b, and a side surface 1c that extends over the four sides of the input device 1. The input device 1 is sized to be held in a hand of the user. A display/operation surface 1d is located in the center of the front surface 1a. The display/operation surface 1d displays a screen that provides a numeric keypad and keyboard or a menu. Various input operations are performed by touching the display/operation surface 1d with a finger.

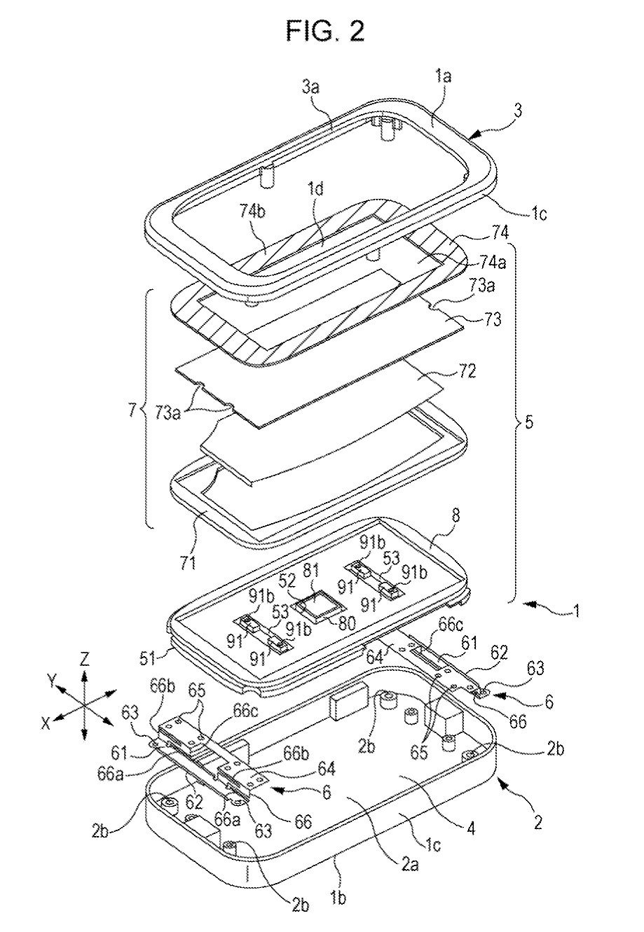

As illustrated in FIG. 2, the input device 1 includes a lower case 2 and an upper case 3 serving as a supporting base. The lower case 2 is made of synthetic resin material. The outer surface of the lower case 2 forms the back surface 1b and a lower part of the side surface 1c.

The upper case 3 is also made of synthetic resin material. The upper case 3 is disposed to cover an opening at the top of the lower case 2. The outer surface of the upper case 3 forms the front surface 1a and an upper part of the side surface 1c. The upper case 3 has a window 3a, which is open to allow the display/operation surface 1d to be placed therein.

The lower case 2 and the upper case 3 are combined together to form a body case, in which a storage space 4 is created. A circuit board and a battery are placed in the storage space 4. As necessary, a reinforcing plate made of metal is secured inside the storage space 4. Addition of the reinforcing plate, as well as the circuit board and the battery, increases the mass of the lower case 2 and the upper case 3, which serve as a supporting base.

A movable unit 5 is disposed inside the storage space 4. The movable unit 5 includes a movable base 51 made of synthetic resin or light metal. Various components are mounted on the movable base 51.

The storage space 4 in the lower case 2 is provided with a plurality of supporting protrusions 2b rising from a bottom wall 2a of the lower case 2. The supporting protrusions 2b are formed integrally with the lower case 2. A pair of first elastic members 6 is secured to the corresponding supporting protrusions 2b. The movable base 51 of the movable unit 5 is supported by the first elastic members 6 such that the movable base 51 can vibrate in the X direction on the lower case 2 serving as part of a base.

The first elastic members 6 are made of metal leaf spring material. The first elastic members 6 each include a base fixed piece 61, which has an upwardly folded portion 62 at an edge thereof for improved rigidity. The base fixed piece 61 is provided with mounting holes 63 at multiple positions. The base fixed piece 61 is placed on the corresponding supporting protrusions 2b and secured thereto with fixing screws inserted into the mounting holes 63.

The first elastic members 6 each have an upper connecting piece 64 provided with mounting holes 65 opening at multiple positions. The upper connecting piece 64 is placed under the lower surface of the movable base 51 of the movable unit 5. The upper connecting piece 64 is secured to the lower surface of the movable base 51 by caulking, or with screws inserted into the mounting holes 65.

The first elastic members 6 each have an elastic deforming part 66 between the base fixed piece 61 and the upper connecting piece 64. The elastic deforming part 66 is parallel to the Y-Z plane. The movable unit 5 supported by the first elastic members 6 can vibrate mainly in the X direction along the plane of the display/operation surface 1d. With slits 66a and 66b and a cutout portion 66c of each elastic deforming part 66, an elastic modulus of the elastic deforming part 66 is adjusted to set a natural vibration frequency at which the entire movable unit 5 vibrates in the X direction. In the present embodiment, the natural vibration frequency at which the entire movable unit 5 vibrates in the X direction is set to 160 Hz.

As illustrated in FIG. 2, in the movable unit 5, a panel assembly 7 is disposed on the movable base 51. The panel assembly 7 includes a movable panel 71 made of synthetic resin or light metal. A second elastic member 8 is disposed in an outer region of the upper surface of the movable base 51. The movable panel 71 is supported to be able to vibrate over the movable base 51, with the second elastic member 8 interposed therebetween.

In the panel assembly 7, a first detector 72 is secured onto the movable panel 71. The first detector 72 is a capacitive detector configured to detect a position of a finger that touches the display/operation surface 1d.

The first detector 72 is formed by a plurality of X scanning electrodes extending in the X direction and a plurality of Y scanning electrodes extending in the Y direction on a resin sheet, which serves as a base material. These scanning electrodes are arranged to be insulated from one another. A driving circuit sequentially applies voltage pulses to the X scanning electrodes and the Y scanning electrodes. When a voltage pulse is applied to any of the X scanning electrodes, a current flows through the Y scanning electrodes at the rising and falling edges of the voltage pulse for a short time. When the display/operation surface 1d is touched by a finger and a voltage pulse is applied to an X scanning electrode near the finger, a large current flows through the finger at the rising and falling edges of the voltage pulse and a value of current flowing through the Y scanning electrodes decreases. By monitoring a current detected by the Y scanning electrodes to determine application of a voltage to which of the X scanning electrodes has caused a change in current, the X coordinate of the location where the finger touches the display/operation surface 1d can be determined.

Similarly, by monitoring changes in value of current flowing through the X scanning electrodes while voltage pulses are being sequentially applied to the Y scanning electrodes, the Y coordinate of the location where the finger touches the display/operation surface 1d can be determined

A display member 73 is secured to the front surface of the first detector 72. The display member 73 is a display sheet. The display member 73 is a light-transmissive sheet, such as a polyethylene terephthalate (PET) sheet, having a numeric keypad and keyboard or a menu printed thereon. With light introduced into the light-transmissive sheet from a light source, such as a light-emitting diode, facing notches 73a of the display member 73, the numeric keypad and keyboard or the menu becomes visible to the user.

The display member 73 may be, for example, an electroluminescent panel, an electrochromic panel, or a liquid crystal panel capable of changing a displayed image.

A cover panel 74 is secured to the front surface of the display member 73. The cover panel 74 is made of light-transmissive material, such as PET or polycarbonate. The cover panel 74 has a rectangular light-transmissive portion 74a in the center thereof and a frame-like non-transmissive portion 74b around the light-transmissive portion 74a. A surface of the light-transmissive portion 74a is equivalent to the display/operation surface 1d described above. The non-transmissive portion 74b is colored by printing or painting.

The first detector 72, the display member 73, and the cover panel 74 are individually secured, with a light-transmissive adhesive interposed therebetween, to the front surface of the movable panel 71. These components are combined together to form the panel assembly 7.

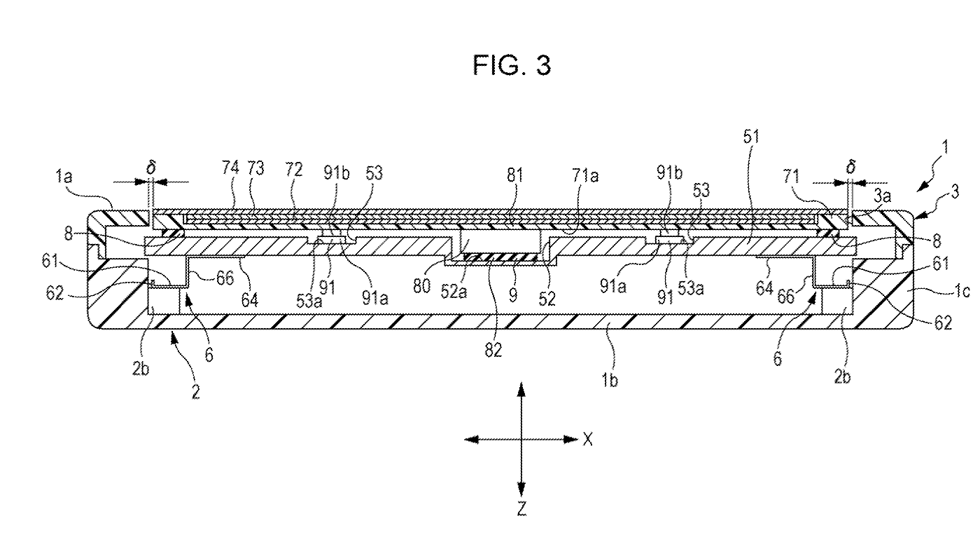

As illustrated in FIG. 3, the upper part of the panel assembly 7 is located inside the window 3a of the upper case 3. The front surface of the cover panel 74 is substantially flush with the front surface 1a of the upper case 3. A very small gap 8 is created between the inner edge of the window 3a and the side face of the panel assembly 7. This allows the panel assembly 7 to move inside the window 3a.

As illustrated in FIG. 2 and FIG. 3, the movable base 51 has a recessed portion 52 in the center of the front surface thereof. The vibration generator 80 is disposed in the recessed portion 52. A front surface 81 of the vibration generator 80 is secured to a back surface 71a of the movable panel 71, with an adhesive interposed therebetween. This means that the vibration generator 80 is included in part of the panel assembly 7.

As illustrated in FIG. 3, a third elastic member 9 is secured by bonding onto a bottom 52a of the recessed portion 52 of the movable base 51. The front surface of the third elastic member 9 is secured with an adhesive to a back surface 82 of the vibration generator 80.

As illustrated in FIG. 3, the panel assembly 7 formed by combining together the movable panel 71, the first detector 72, the display member 73, the cover panel 74, and the vibration generator 80 is supported by the second elastic member 8 and the third elastic member 9 such that the panel assembly 7 can vibrate over the movable base 51.

The second elastic member 8 and the third elastic member 9 are made of rubber material or foamed resin material. The elastic modulus of the second elastic member 8 and the third elastic member 9 in the front-back direction (Z direction) orthogonal to the display/operation surface 1d is set by adjusting the area of the second elastic member 8 and the third elastic member 9. When the movable base 51 is at rest, the panel assembly 7 can vibrate in the front-back direction (Z direction) at a natural vibration frequency determined by the elastic modulus described above and the mass of the entire panel assembly 7. The natural vibration frequency of the panel assembly 7 is set to a value different from a natural vibration frequency at which the entire movable unit 5 vibrates in the X direction. In the present embodiment, the natural vibration frequency of the panel assembly 7 in the front-back direction (Z direction) is set to 480 Hz.

As illustrated in FIG. 2 and FIG. 3, the front surface of the movable base 51 has two recessed portions 53 on both sides of the vibration generator 80. Two second detectors 91 are disposed in each of the two recessed portions 53. Each of the four second detectors 91 has a main body 91a and a sensing protrusion 91b. The main body 91a is secured to a bottom 53a of the corresponding recessed portion 53 with an adhesive or the like. The sensing protrusion 91b is in contact with the back surface 71a of the movable panel 71 without being secured thereto.

The second detectors 91 each are a force sensor. The main body 91a of each second detector 91 has rigidity. An upper plate portion of the main body 91a integral with the sensing protrusion 91b has elasticity and thus can deform flexibly. A strain sensor or a piezoelectric element is attached to the upper plate portion. When a pressing force is applied to the sensing protrusion 91b in the Z direction, the upper plate portion of the main body 91a deforms flexibly. Thus, a detection output corresponding to the magnitude of the applied pressing force can be obtained from the strain sensor or piezoelectric element.

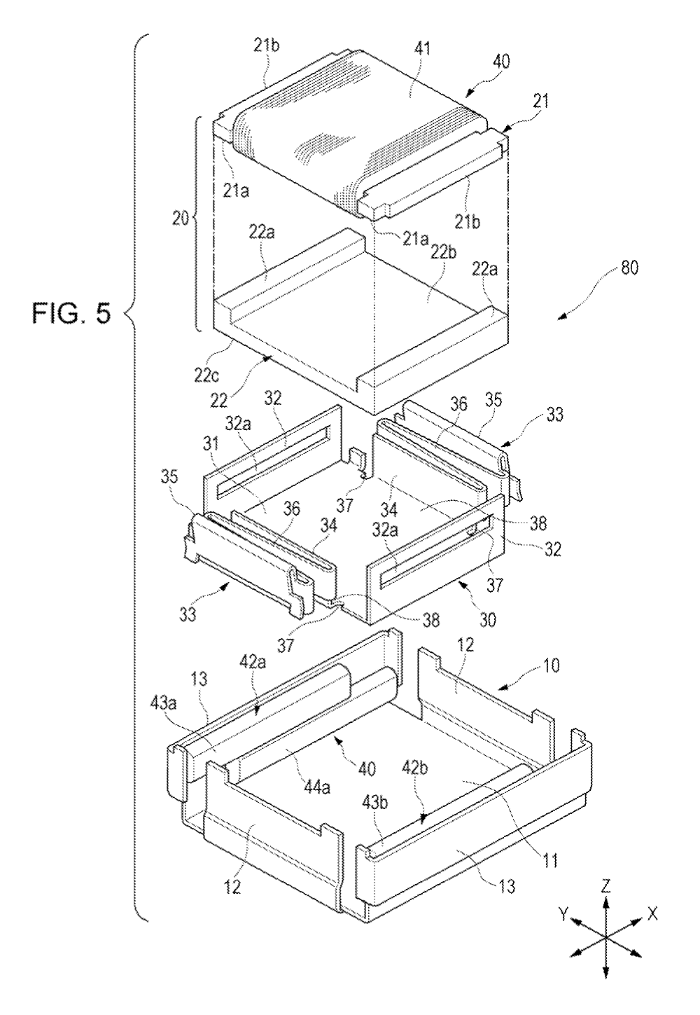

FIG. 5 to FIGS. 9A and 9B illustrate details of a structure of the vibration generator 80. The vibration generator 80 can generate vibration having a first vibration frequency with an amplitude in the X direction along the plane of the display/operation surface 1d, and can also generate vibration having a second vibration frequency with an amplitude in the Z direction orthogonal to the display/operation surface 1d.

The first vibration frequency is equal to the natural vibration frequency at which the entire movable unit 5 vibrates in the X direction. The first vibration frequency is 160 Hz in the present embodiment. The second vibration frequency is equal to the natural vibration frequency at which the panel assembly 7 vibrates in the Z direction. The second vibration frequency is 480 Hz in the present embodiment.

As illustrated in FIG. 5, the vibration generator 80 includes a housing 10, a vibrating body 20, a supporting body 30 that holds the vibrating body 20, and elastic supporting members 33 that support the vibrating body 20 and the supporting body 30 inside the housing 10. A magnetic driving unit 40 is interposed between the housing 10 and the vibrating body 20.

As illustrated in FIG. 5, the housing 10 is an integral unit including a bottom plate 11, a pair of fixed plates 12 formed by bending and extending upright from the bottom plate 11 to face each other in the X direction, and a pair of magnet supporting plates 13 formed by bending and extending upright from the bottom plate 11 to face each other in the Y direction.

The vibrating body 20 includes a magnetic core 21 and a magnetic yoke 22. The magnetic core 21 is a plate-like member made of magnetic metal material. A coil 41 that forms the magnetic driving unit 40 is wound around the magnetic core 21. The coil 41 is formed by winding multiple turns of copper wire around the magnetic core 21.

The magnetic yoke 22 is made of the same magnetic metal material as the magnetic core 21. The magnetic yoke 22 has a recessed portion 22b in the center thereof. Connecting surfaces 22a facing upward are formed on both sides of the recessed portion 22b in the Y direction. When the magnetic core 21 is placed on the magnetic yoke 22, the lower half of the coil 41 is fitted in the recessed portion 22b. Connecting surfaces 21a of protruding portions protruding from the coil 41 on the magnetic core 21, the connecting surfaces 21a facing downward, are placed on, and connected to, the respective connecting surfaces 22a of the magnetic yoke 22 and secured thereto with an adhesive or the like.

The supporting body 30 that supports the vibrating body 20 is formed by bending a leaf spring. For example, the housing 10 is formed by a magnetic plate, such as a ferrous plate, and the supporting body 30 is formed by a non-magnetic metal plate, such as a stainless plate. The supporting body 30 has a supporting bottom 31 and a pair of opposite plates 32 formed by bending and extending upright from the supporting bottom 31 to face each other in the Y direction. Each of the opposite plates 32 has a long narrow opening 32a extending in the X direction.

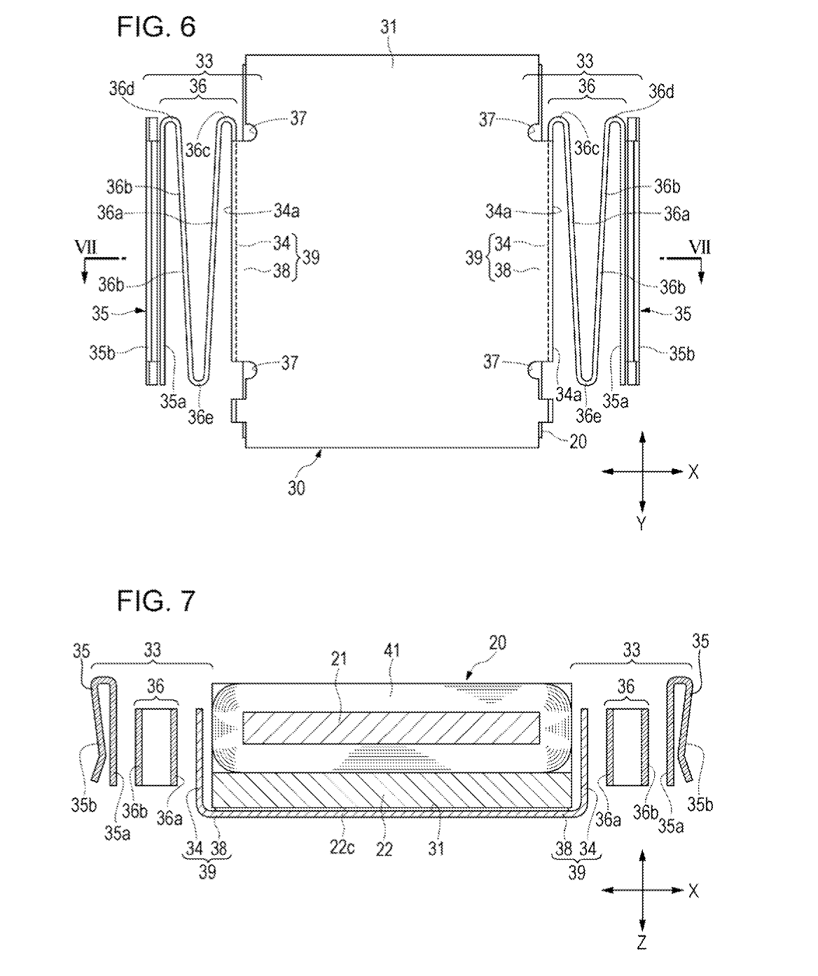

As illustrated in FIG. 6 and FIG. 7, the vibrating body 20 is mounted on the supporting body 30. As illustrated in FIG. 5, protruding end portions 21b protruding further from the respective connecting surfaces 21a in the Y direction are formed integrally with the magnetic core 21. The protruding end portions 21b are fitted into the respective openings 32a of the opposite plates 32. Thus, the vibrating body 20 is secured in position to the supporting body 30.

The elastic supporting members 33 continuous with the supporting bottom 31 are integrally formed on both sides of the supporting body 30 in the X direction.

As illustrated in FIG. 5 and FIG. 6, the elastic supporting member 33 protruding from one side of the supporting bottom 31 in the X direction and the elastic supporting member 33 protruding from the other side of the supporting bottom 31 in the X direction are symmetrical in structure with respect to the Y-Z plane.

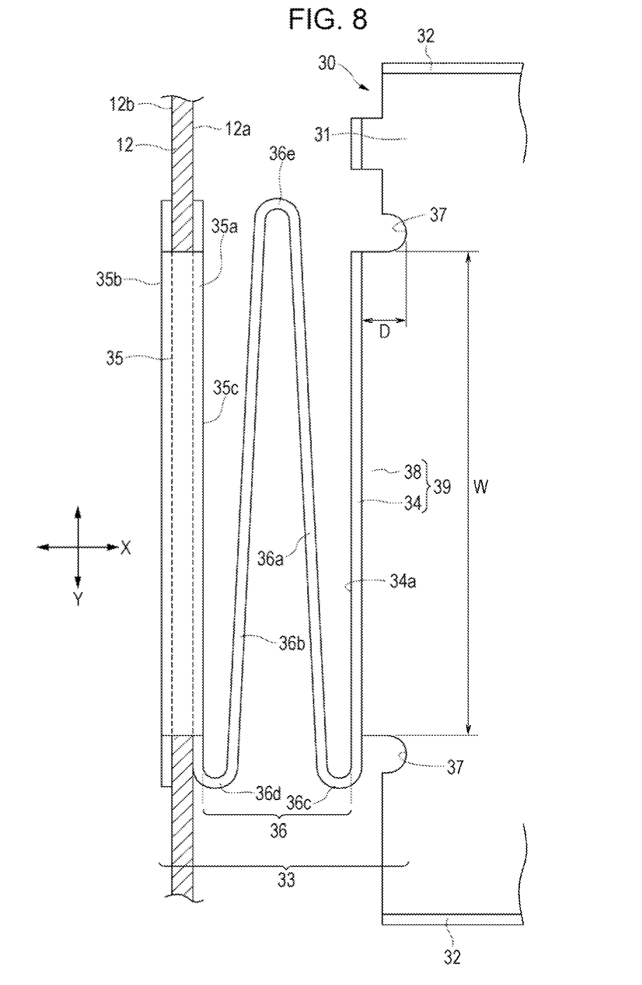

As illustrated in the enlarged view of FIG. 8, each elastic supporting member 33 has an intermediate plate 34. As illustrated in FIG. 7, the intermediate plate 34 is formed by upward bending (in the Z direction) and extends upright from one side of the supporting bottom 31 of the supporting body 30 facing in the X direction. In FIG. 8, the length of the intermediate plate 34 in the Y direction is indicated by W.

The elastic supporting member 33 has a pinching part 35 spaced outwardly from the intermediate plate 34 in the X direction. As illustrated in FIG. 7, the pinching part 35 is an integral part having a retaining plate 35a and an elastic retaining piece 35b formed by bending. The retaining plate 35a is parallel to the intermediate plate 34, and the elastic retaining piece 35b extends to face the retaining plate 35a. As illustrated in FIG. 8, the fixed plate 12 of the housing 10 is sandwiched between the retaining plate 35a and the elastic retaining piece 35b. Thus, the retaining plate 35a is brought into intimate contact with an inner surface 12a of the fixed plate 12, the elastic retaining piece 35b is elastically pressed against an outer surface 12b of the fixed plate 12, and the pinching part 35 is secured to the fixed plate 12.

As illustrated in FIG. 8, an outer surface 34a of the intermediate plate 34 and an inner surface 35c of the retaining plate 35a are parallel to each other, between which a first elastic deforming part 36 is interposed. The first elastic deforming part 36 is made of the same leaf spring material as the supporting body 30. The first elastic deforming part 36 is formed integrally with the intermediate plate 34 and the retaining plate 35a.

The first elastic deforming part 36 has two deforming plates 36a and 36b. The deforming plates 36a and 36b have a band-like shape, larger in length in the Y direction than in width in the Z direction. The deforming plates 36a and 36b have a thickness in the X direction, a width in the Z direction, and a length in the Y direction.

One end (or base) of the deforming plate 36a is connected via a base bend 36c to the intermediate plate 34, and one end (or base) of the deforming plate 36b is connected via a base bend 36d to the retaining plate 35a. The other end of the deforming plate 36a is connected to the other end of the deforming plate 36b via an intermediate bend 36e.

The deforming plate 36a and the deforming plate 36b produce a bending strain mainly in the X direction, and the curvature is in the Y direction. The base bend 36c, the base bend 36d, and the intermediate bend 36e each have a bend line in the Z direction, and produce a bending strain mainly in the X direction.

Under the bending strains of the deforming plates 36a and 36b and the bending strains of the base bends 36c and 36d and the intermediate bend 36e, the first elastic deforming part 36 has a first elastic modulus and elastically deforms in the X direction. The magnitude of bending stress required to apply a bending strain to the first elastic deforming part 36 in the X direction is small, and the first elastic modulus is relatively small. Because of the strain applied to the first elastic deforming part 36 in the X direction, the vibrating body 20 and the supporting body 30 having the vibrating body 20 mounted thereon can vibrate at the first vibration frequency in the X direction.

The first vibration frequency at which the vibrating body 20 vibrates in the X direction is determined by the total mass of the vibrating body 20 and the supporting body 30 and the first elastic modulus described above. Since the first elastic modulus is relatively small, the first vibration frequency is relatively low and is 160 Hz in the present embodiment.

As illustrated in FIG. 8, the elastic supporting member 33 has notches 37 at both ends of the intermediate plate 34. The notches 37 are cut into the supporting bottom 31 of the supporting body 30 in the X direction. In FIG. 8, the cut depth of the notches 37 is indicated by D. A portion of the leaf spring forming the supporting bottom 31 and interposed between the notches 37, the portion being defined by the width W and the cut depth D in FIG. 8, is a deforming plate 38. The deforming plate 38 is not secured, with an adhesive or the like, to a lower surface 22c of the magnetic yoke 22 that forms the vibrating body 20. A second elastic deforming part 39 is formed by the deforming plate 38 and the intermediate plate 34 formed by bending and extending from the deforming plate 38.

The second elastic deforming part 39 elastically deforms when the vibrating body 20 and the supporting body 30 vibrate in the Z direction. The second elastic deforming part 39 primarily deforms in the deforming plate 38. When the vibrating body 20 and the supporting body 30 move in the Z direction, the deforming plate 38 produces a bending strain in the Z direction. At the same time, a bending strain occurs along the bending boundary between the intermediate plate 34 and the deforming plate 38.

The deforming plate 38, which is a primary deforming portion of the second elastic deforming part 39, is long in the width direction (Y direction) and short in the direction of curvature (X direction) when bent. Therefore, a second elastic modulus of the second elastic deforming part 39 when bent by vibration of the vibrating body 20 and the supporting body 30 in the Z direction is much higher than the first elastic modulus of the first elastic deforming part 36 in the X direction. The second vibration frequency at which the vibrating body 20 and the supporting body 30 vibrate in the Z direction is determined by the mass of the vibrating body 20 and the supporting body 30 and the second elastic modulus. The second vibration frequency is higher than the first vibration frequency and is 480 Hz in the present embodiment.

As illustrated in FIG. 5, the housing 10 has the pair of magnet supporting plates 13 facing each other in the Y direction. A magnetic field generator 42a that forms the magnetic driving unit 40, together with the coil 41, is secured to the inner surface of one of the magnet supporting plates 13. A magnetic field generator 42b that also forms the magnetic driving unit 40, together with the coil 41, is secured to the inner surface of the other of the magnet supporting plates 13.

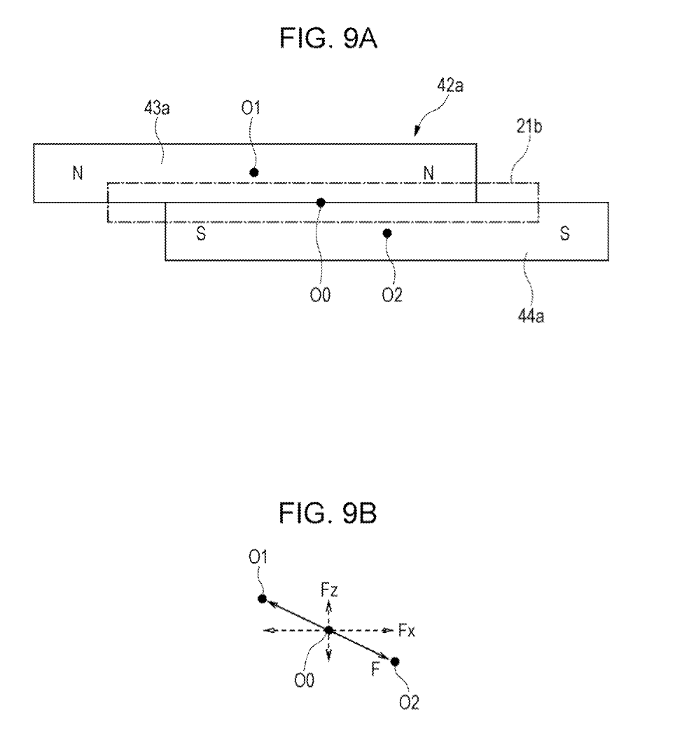

As illustrated in FIG. 9A, the magnetic field generator 42a includes an upper magnet 43a on the upper side and a lower magnet 44a on the lower side adjacent to the bottom plate 11. Both the upper magnet 43a and the lower magnet 44a have a long narrow shape, larger in length in the X direction than in width in the Z direction. A center O1 of the upper magnet 43a is located on the left side in FIG. 9A, and a center O2 of the lower magnet 44a is located on the right side in FIG. 9A. A surface of the upper magnet 43a facing the protruding end portion 21b of the magnetic core 21 is north polarized, whereas a surface of the lower magnet 44a facing the protruding end portion 21b is south polarized.

When no external force acts on the vibrating body 20 and the vibrating body 20 is supported in a neutral position by the elastic supporting members 33, a center O0 of the protruding end portion 21b of the magnetic core 21 is located at the midpoint between the center O1 and the center O2 in both the X and Z directions.

The magnetic field generator 42b (see FIG. 5) facing the magnetic field generator 42a illustrated in FIG. 9A is symmetrical in structure with the magnetic field generator 42a with respect to the X-Z plane. The magnetic field generator 42b includes an upper magnet 43b plane-symmetrical with the upper magnet 43a and a lower magnet 44b (not shown in FIG. 5) plane-symmetrical with the lower magnet 44a. In the magnetic field generator 42b, a surface of the upper magnet 43b facing the protruding end portion 21b of the magnetic core 21 is south polarized, whereas a surface of the lower magnet 44b facing the protruding end portion 21b is north polarized. This means that the surfaces of the upper magnet 43a and the upper magnet 43b facing each other have opposite magnetic polarities, and the surfaces of the lower magnet 44a and the lower magnet 44b facing each other have opposite magnetic polarities.

The vibration generator 80 has two vibration modes. A first vibration mode provides resonance at the first vibration frequency at which the vibrating body 20 and the supporting body 30 vibrate in the X direction. A second vibration mode provides resonance at the second vibration frequency at which the vibrating body 20 and the supporting body 30 vibrate in the Z direction.

When the vibration generator 80 is driven in the first vibration mode, a first driving signal having a first frequency equal to the first vibration frequency or a frequency close to the first vibration frequency is applied to the coil 41. Thus, a frequency at which the magnetic polarity of the surface of the protruding end portion 21b of the magnetic core 21 is reversed to north or south becomes equal to or close to the first vibration frequency.

When the coil 41 is energized and the protruding end portions 21b of the magnetic core 21 function as magnetic poles, a driving force F (see FIG. 9B) acts on the center O0 of each protruding end portion 21b in the direction of a straight line in which the centers O1, O0, and O2 lie. If the driving signal has the first frequency or a frequency close to the first frequency, a component Fx of the driving force F in the X direction causes the vibrating body 20 and the supporting body 30 to resonate in the X direction in the first vibration mode.

When the vibration generator 80 is driven in the second vibration mode, a second driving signal having a second frequency equal to the second vibration frequency or a frequency close to the second vibration frequency is applied to the coil 41. Thus, a component Fz of the driving force F in the Z direction causes the vibrating body 20 and the supporting body 30 to resonate in the Z direction in the second vibration mode.

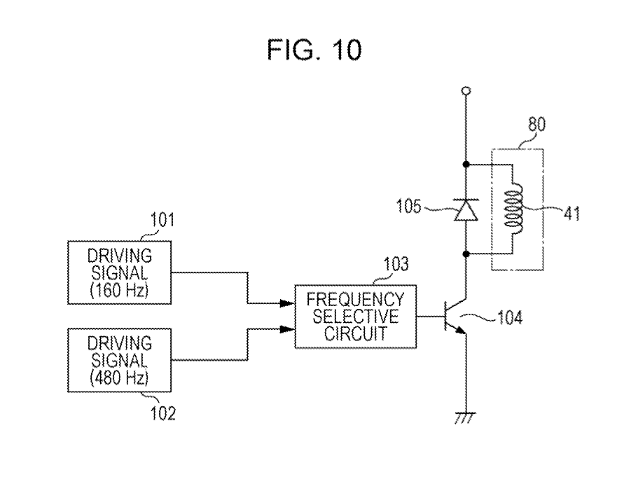

A driving circuit unit illustrated in FIG. 10 is mounted on the circuit board in the storage space 4 of the input device 1. The driving circuit unit includes an oscillator 101 that generates the first driving signal of 160 Hz and an oscillator 102 that generates the second driving signal of 480 Hz. The first driving signal or the second driving signal is selected by a frequency selective circuit 103 and applied to a transistor 104 functioning as a switch. The coil 41 of the vibration generator 80 is connected in parallel to a diode 105. A supply voltage is applied to this parallel connection portion, and a driving current of appropriate frequency is applied to the coil 41 by the switching function of the transistor 104.

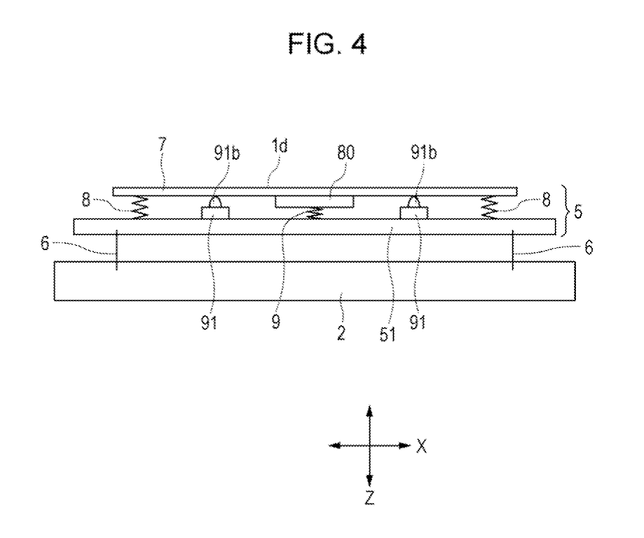

FIG. 4 schematically illustrates a supporting structure and a vibrating structure of the input device 1.

The input device 1 includes the lower case 2 (and the upper case 3) serving as a supporting base. The entire movable unit 5 is supported on the lower case 2, with the first elastic members 6 interposed therebetween, such that the movable unit 5 can vibrate in the X direction along the plane of the display/operation surface 1d. At the same time, the panel assembly 7 including the vibration generator 80 is supported by the second elastic member 8 and the third elastic member 9 on the movable base 51, such that the panel assembly 7 can vibrate in the Z direction orthogonal to the display/operation surface 1d.

As described above, the natural vibration frequency at which the entire movable unit 5 vibrates in the X direction is 160 Hz, and the natural vibration frequency at which the panel assembly 7 vibrates on the movable base 51 in the Z direction is 480 Hz.

When a finger touches the display/operation surface 1d of the input device 1, the first detector 72 can detect the position at which the display/operation surface 1d is touched. When the display/operation surface 1d is pressed with the finger, the second elastic member 8 and the third elastic member 9 are deformed by compression in the Z direction. This causes the panel assembly 7 including the vibration generator 80 to move in a direction toward the movable base 51. The resultant force acting on the sensing protrusions 91b is detected by the second detectors 91. Thus, the pressing force applied to the display/operation surface 1d is detected.

By a display operation of the display member 73 included in the panel assembly 7, a numeric keypad and keyboard or a menu is displayed on the display/operation surface 1d. The first detector 72 and the second detectors 91 detect which section of the display is touched by the finger, or detect whether the display/operation surface 1d is held down.

In accordance with the detecting operation described above, the driving circuit unit (controller) drives either the oscillator 101 for the first driving signal or the oscillator 102 for the second driving signal illustrated in FIG. 10. Then, an appropriate frequency is selected by the frequency selective circuit 103, and a driving current for generating the first vibration frequency or the second vibration frequency is applied to the coil 41 of the vibration generator 80.

If the first driving signal is applied to the coil 41, the vibration generator 80 generates vibration in the X direction. Here, the first vibration frequency is 160 Hz. The natural vibration frequency of the panel assembly 7 on the movable base 51 is 480 Hz, which is far from the first vibration frequency. Therefore, the entire movable unit 5 is vibrated in the X direction at 160 Hz by the vibration generated by the vibration generator 80.

If the second driving signal is applied to the coil 41, the vibration generator 80 generates vibration in the Z direction. Here, the second vibration frequency is 480 Hz, which is greatly different from the first vibration frequency of 160 Hz. Therefore, the panel assembly 7 vibrates in the Z direction while the movable base 51 is at rest.

When the movable unit 5 vibrates at a low frequency of 160 Hz, the vibration along the plane of the display/operation surface 1d is applied to the finger touching the display/operation surface 1d. If small vibration is applied at a relatively low frequency to the display/operation surface 1d, the finger is more sensitive to the vibration in the X direction than to the vibration in the Z direction. When the entire movable unit 5 vibrates in the X direction, the vibration can be easily felt with the finger, and a large operation reaction force can be applied to the finger operating the display/operation surface 1d.

The mass of the lower case 2 serving as a supporting base is substantially greater than that of the entire movable unit 5, because the circuit board, the battery, and the reinforcing plate are secured to the lower case 2 as described above. This means that the lower case 2 does not easily vibrate when the entire movable unit 5 vibrates in the X direction. Thus, since vibration from the vibration generator 80 can be effectively applied to the display/operation surface 1d, the vibration generator 80 does not necessarily have to be one that produces a very large output.

When the second driving signal is given, the display/operation surface 1d vibrates in the Z direction. Since the frequency of this vibration is high, vibration of high frequency is applied to the finger that touches the display/operation surface 1d. Thus, the user can feel an operation reaction force different from that applied when the first driving signal is given.

As illustrated in FIG. 4, the input device 1 has a structure in which the panel assembly 7 is supported by the second elastic member 8 and the third elastic member 9. With this structure, a pressing force can easily act on the second detectors 91 in response to a press of the display/operation surface 1d. Additionally, the display/operation surface 1d can vibrate in two different vibration modes.

The first detector 72 included in the panel assembly 7 is a capacitive detector in the embodiment described above. However, the first detector 72 may either be a contact detector in which opposite electrodes are brought into contact, or a resistive detector in which opposite resistance films are brought into contact. In either case, the first detector 72 may be disposed on the surface of the cover panel 74.

1. An input device comprising:
a supporting base; and
a movable unit disposed over the supporting base with a first elastic member interposed therebetween, the movable unit being capable of vibrating, the movable unit including:
an operation surface;
a detector configured to detect an operation on the operation surface; and
a vibration generator configured to apply vibrations to the operation surface,
wherein the vibration generator generates a vibration having a first vibration frequency equal to a natural vibration frequency of the movable unit in a direction along the operation surface.

2. The input device according to claim 1, wherein the movable unit includes:
a movable base supported by the first elastic member; and
a movable panel provided with the operation surface, the detector, and the vibration generator, the movable panel being supported over the movable base by a second elastic member interposed therebetween such that the movable panel is capable of vibrating,
and wherein the vibration generator further generates a vibration having a second vibration frequency equal to a natural vibration frequency of the movable panel, the first vibration frequency being the natural vibration frequency of the entire movable unit.

3. The input device according to claim 2, wherein the vibration generator vibrates the entire movable unit in a direction along the operation surface, and vibrates the movable panel in a direction intersecting the operation surface.

4. The input device according to claim 2, further comprising:
a first detector configured to detect a position of operation on the operation surface mounted on the movable panel;
a second detector configured to detect a pressing force applied to the movable panel mounted on the movable base,
wherein the vibration generator is secured to the movable panel.

5. The input device according to claim 1, wherein a mass of the supporting base is larger than a mass of the entire movable unit.

6. An input device comprising:
a supporting base provided as a case; and
a movable unit supported on the supporting base by a first elastic member interposed therebetween, the movable unit including:
a movable base, and
a movable panel supported on the movable base by a second elastic member interposed therebetween, the movable panel including:
an operation surface;
a first detector configured to detect a position of operation on the operation surface; and
a vibration generator configured to generate a vibration having a first vibration frequency equal to a natural vibration frequency of the entire movable unit and a vibration having a second vibration frequency equal to a natural vibration frequency of the movable panel,
wherein the movable base has a second detector configured to detect a pressing force applied to the movable panel.

7. The input device according to claim 6, wherein the vibration generator is secured to the movable panel, the input device further comprising:
a third elastic member interposed between the movable base and the vibration generator.

8. The input device according to claim 6, wherein the vibration generator vibrates the entire movable unit in a direction along the operation surface, and vibrates the movable panel in a direction intersecting the operation surface.
